(19) United States
(12) Patent Application Publication
(10) Pub. No.: US 2022/0223016 A1
(43) Pub. Date: Jul. 14, 2022

(54) IMAGE CAPTURING APPARATUS

(71) Applicant: CANON KABUSHIKI KAISHA, Tokyo (JP)

(72) Inventor: Yusaku Oe, Kanagawa (JP)

(21) Appl. No.: 17/565,300

(22) Filed: Dec. 29, 2021

(30) Foreign Application Priority Data
Jan. 14, 2021 (JP) 2021-004059

(51) Int. Cl. G08B 13/196; H04N 5/232

(52) U.S. Cl. CPC G08B 13/1963; H04N 5/23296; H04N 5/23238; G08B 13/19619

(57) ABSTRACT

An image capturing apparatus is provided with a plurality of image capturing units that capture images in directions that differ from one another, an approximately spherical housing that houses the plurality of image capturing units and that is rotatable around a tilt axis, and a drive unit that drives the housing to be rotated around a tilt axis, and in which at least a portion of the drive unit is disposed inside the housing.

### BACKGROUND OF THE INVENTION

### Field of the Invention

The present invention is related to an image capturing apparatus, and in particular, is related to decreasing the size of a surveillance camera.

### Description of Related Art

A surveillance camera that synthesizes video images that are captured by a plurality of image capturing units, and outputs a panorama image is known.

For example, the surveillance camera that is disclosed in U.S. Pat. No. 10,674,048 can capture a 180-degree panorama image by synthesizing the video images from a plurality of image capturing units. In addition, the plurality of image capturing units can pan and tilt rotate while maintaining their relative positions, and the angle of view of the panorama image can be adjusted according to the location that the user would like to capture. In this surveillance camera, pan/tilt rotation adjustments are performed manually.

In the surveillance camera that is disclosed in U.S. Pat. No. 10,721,400 as well, a panorama image can be captured by a plurality of pan/tilt rotatable image capturing units. In this surveillance camera, pan/tilt adjustment is also carried out manually by the user.

In the above explained conventional surveillance cameras that output panorama images that have been disclosed in U.S. Pat. Nos. 10,674,048 and 10,721,400, it is necessary to manually perform adjustments to the pan and tilt directions directly on the surveillance camera at the installation location. Due to this, it is difficult to adjust the angle of view while checking the panorama image that is actually being captured.

If a drive mechanism that can perform pan and tilt rotation electrically is disposed in the above explained surveillance cameras, it would make the adjustment of the angle of view by remote operation while checking the image that is being captured possible. However, in surveillance cameras that capture images with a plurality of image capturing units, there is the problem that disposing the drive mechanism in such a way that the drive mechanism does not enter into the angle of view is difficult. In particular, in a tilt drive mechanism, it is necessary to dispose mechanisms such as gears and the like close to the image capturing units. Due to this, when attempting to dispose a drive mechanism that avoids the angle of view of the image capturing units, there is the problem that it is necessary to maintain a distance between the image capturing units and the drive mechanism, and the entirety of the surveillance camera will increase in size.

### SUMMARY OF THE INVENTION

Embodiments of the present invention are provided with a plurality of image capturing units, and allow for a decrease in the size of an image capturing apparatus in which electrically adjusting the image capturing direction is possible.

One embodiment of the present invention is provided with a plurality of image capturing units that capture images in directions that differ from one another, an approximately spherical housing that houses the plurality of image capturing units and is rotatable around a tilt axis, and a drive unit that drives the housing to rotate around the tilt axis, wherein at least a portion of the drive unit is disposed inside of the housing.

Further features of the present invention will become apparent from the following description of exemplary embodiments with reference to the attached drawings.

### BRIEF DESCRIPTION OF THE DRAWINGS

FIG. 1 is a perspective view of a surveillance camera in the first embodiment.

FIG. 2 is an exploded perspective view of the surveillance camera that is shown in FIG. 1.

FIG. 3 is a block diagram showing the configuration of a surveillance system including a surveillance camera.

FIG. 4 is a perspective diagram showing the internal structure of a tilt drive unit of the surveillance camera that is shown in FIG. 1.

FIG. 5 is a perspective diagram showing the internal structure of a pan drive unit of a surveillance camera.

FIG. 6 is an exploded perspective diagram showing the internal structure of a surveillance camera in the second embodiment.

### DESCRIPTION OF THE EMBODIMENTS

### First Embodiment

The details of a preferred embodiment of the present invention will be explained in detail below with reference to the attached drawings.

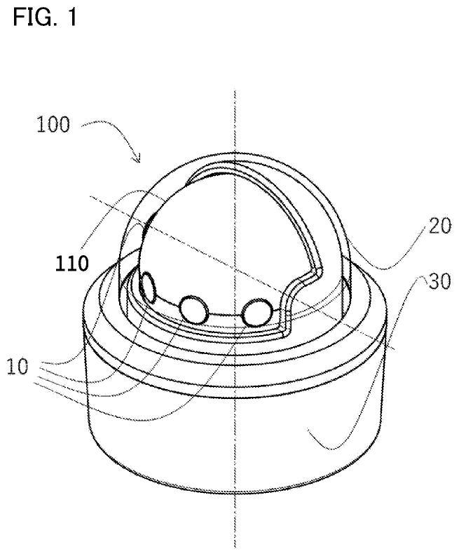

First, a surveillance camera 100 of the first embodiment will be explained. FIG. 1 is a perspective diagram of the surveillance camera 100 in the first embodiment. As shown in FIG. 1, the surveillance camera 100 has four image capturing units 10 disposed along the surface of a housing 110, a dome 20, and a case 30. Note that, in this context, although the housing 110 is spherical as an example, it does not need to be a perfect sphere. That is, the housing 110 may be approximately spherical.

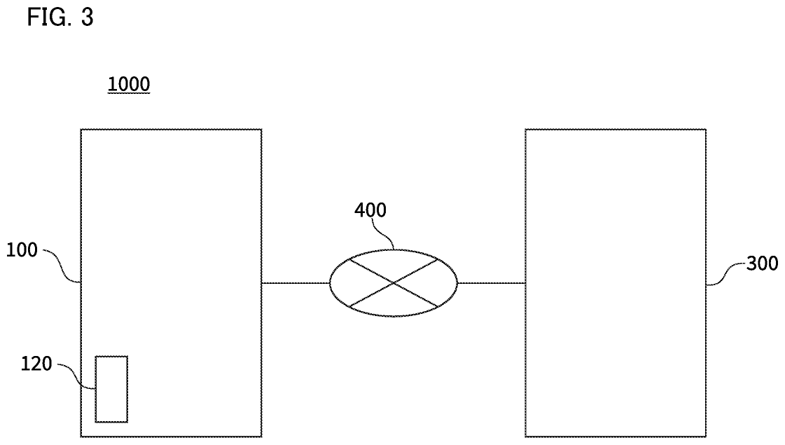

For example, the surveillance camera that is shown in FIG. 1 can output a 180-degree panorama image (video image) by synthesizing the images that are captured by the plurality of image capturing units 10. That is, the surveillance camera 100 may be provided with an image generating unit 120 (shown in FIG. 3) that generates a panorama image by synthesizing a plurality of images that are captured by the plurality of image capturing units 10. In the present embodiment, four image capturing units 10 are used as an example. For example, the surveillance camera 100 can be disposed on the ceiling of a building, the side of a utility pole in the center of an intersection, or the like as its instillation surface. The surveillance camera 100 in the present embodiment can capture panorama video images in a wide range of, for example, 180 degrees, and can help to ensure security.

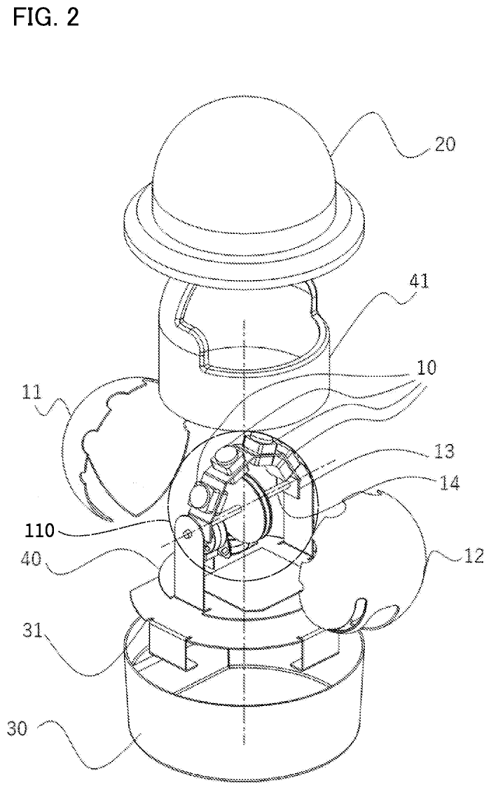

FIG. 2 is an exploded perspective view of the surveillance camera 100 that is shown in FIG. 1. As shown in FIG. 2, the four image capturing units 10 are fixed to an image capturing unit support member 13. The image capturing unit support member 13 has a tilt shift 14 (tilt axis), and for example, is supported with respect to a tilt support member 40 so as to make 90-degree tilt rotation around the tilt shaft 14 possible. In addition, the tilt support member 40 is supported so as to be pan rotatable by a base unit 31. That is, the four image capturing units 10 are able to pan and tilt rotate while maintaining their respective relative positions. This is advantageous in generating the synthesized images, particularly a panorama image.

The housing 110 is provided with a first image capturing unit case 11, and a second image capturing unit case 12. The first image capturing case 11 and the second image capturing case 12 are fixed to the image capturing unit support member 13 so as to cover the four image capturing units 10. In other words, the housing 110 houses the plurality of image capturing units 10. The housing 110 is made rotatable around the tilt shaft 14 by a tilt drive unit 50 to be described below. In addition, a tilt support member case 41 is fixed to the tilt support member 40, and is disposed so as to cover the first image capturing unit case 11 and the second image capturing unit case 12.

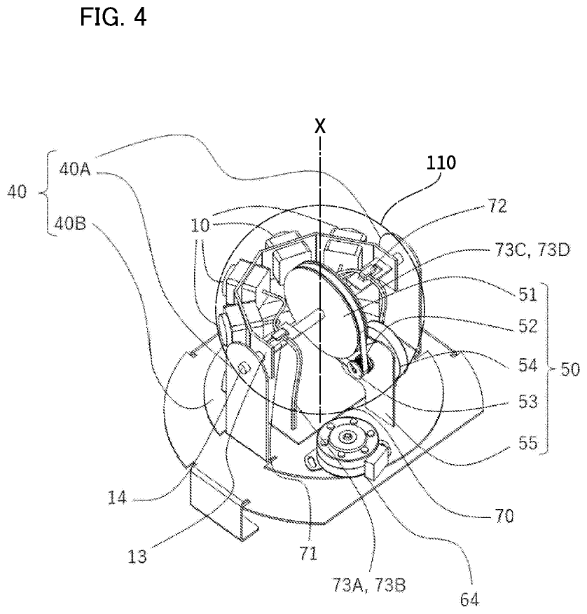

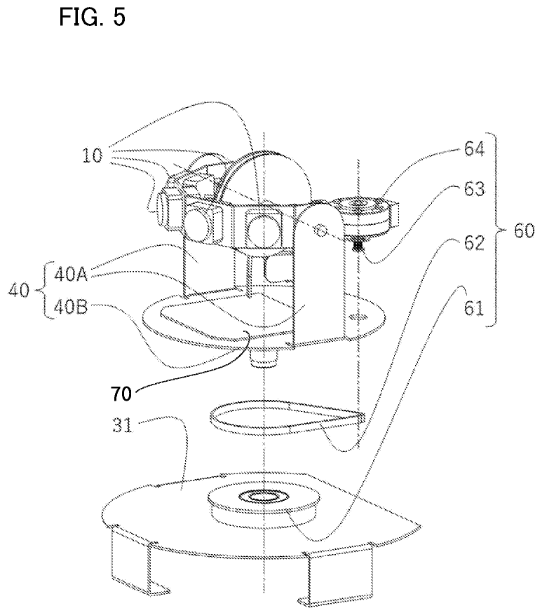

FIG. 3 is a block diagram showing the configuration of a surveillance system 1000 that includes the surveillance camera 100. The surveillance system 1000 includes the surveillance camera 100, and a client apparatus (an information processing apparatus) 300. The surveillance camera 100 is communicably connected with the client apparatus 300, which is an external device, via a network 400. The surveillance camera 100 is provided with a tilt drive unit 50, which is described in detail in FIG. 4, and a pan drive unit 60, which is described in detail in FIG. 5, and can tilt or pan rotate the four image capturing units 10 electrically. The tilt drive unit 50 and the pan drive unit 60 drive the image capturing units 10 based on commands from the client apparatus 300. That is, using the client apparatus 300, a user can pan/tilt drive the four image capturing units 10 by remote operation, and adjust the image capturing direction (the pan/tilt direction) of the surveillance camera 100.

FIG. 4 is a perspective diagram showing the internal structure of the tilt drive unit 50 of the surveillance camera 100 that is shown in FIG. 1. The four image capturing units 10 are, for example, disposed along the top of an approximately 180-degree arc on top of the housing 110 so as to make capturing a 180-degree panorama video image possible. That is, the plurality of image capturing units 10 are disposed so as to capture images in directions that differ from one another and are centered on a predetermined axis X. The axis X is approximately the same as the central axis of the housing 110, and is approximately orthogonal to the tilt axis. Due to this, in the interior of the housing 110, there is space that is enclosed by a plurality of image capturing units 110 and space in which image capturing units 10 are not disposed. At least a portion of the tilt drive unit 50 is disposed inside the housing 110, in other words, by disposing at least a portion the tilt drive unit 50 in the space that is surrounded by the plurality of image capturing units 10, the empty space is utilized and the enlargement of the entirety of the surveillance camera 100 can be prevented. In addition, the tilt drive unit 50 can also be prevented from entering into the angle of view of the image capturing units 10.

As shown in FIG. 4, the tilt drive unit 50 is provided with a tilt pulley 51, a timing belt 52, a pinion 53, a tilt motor 54, and a tilt motor bracket 55. In this context, the tilt motor 54 is fixed to the tilt motor bracket 55, and the tilt motor bracket 55 is fixed to the tilt support member 40. In addition, the tilt pulley 51 is fixed to the approximate center of the tilt shaft 14, and is disposed in the interior of the housing 110.

The timing belt 52 is disposed so that the driving force of the pinion 53, which is fixed to the shaft of the tilt motor 54, is transmitted to the tilt pulley 51, and the image capturing units 10 can thereby be electrically tilt driven. That is, the timing belt 52 can be said to be a power transmitting unit. At least a portion of the timing belt 52 is disposed to overlap with the axis X. In other words, the timing belt 52 is disposed on the approximate center of the housing 110, which is spherical in the direction of the tilt axis. An even further decrease in size is thereby possible.

The tilt motor bracket 55 is fixed on the bottom unit 40 B of the tilt support member 40, and is also disposed in the space that is interposed between the pair of tilt support units 40 A. In addition, a portion of the tilt drive member 50 is disposed in the interior of the housing 110. In a case in which, for example, the tilt rotatable range of the surveillance camera 100 is 0° to 90°, even if a portion of the tilt drive unit 50 has been disposed outside of the housing 110, the tilt rotation will not be hindered. Note that, the entirety of the tilt drive unit 50 may also be disposed in the interior of the housing 110. In this case, it is possible to widen the tilt rotatable range of the surveillance camera 100.

FIG. 5 is a perspective diagram showing the internal structure of the pan drive unit 60 of the surveillance camera 100 that is shown in FIG. 1. As shown in FIG. 5, the pan drive unit 60 is provided with a pan pully 61, a timing belt 62, a pinion 63, and a pan motor 64. At this time, the pan motor 64 is fixed to the tilt support member 40, and the pan pulley 61 is fixed to the base member 31. In addition, the timing belt 62 is disposed in such a way that the driving force of the pinion 63, which is fixed to the pan motor 64, is transmitted to the pan pulley 61. The tilt support member 40 can thereby be electrically pan driven.

The pan motor 64 is fixed to the bottom unit 40 B of the tilt support member 40, and is also disposed in the space that is interposed between the two tilt support units 40 A. As shown in FIG. 4, a main substrate 70 performs control of the tilt drive unit 50 and the pan drive unit 60. The main substrate 70 is fixed to the bottom unit 40 B of the tilt support member 40, and is also disposed in the space that is interposed between the two tilt support units 40 A.

By disposing the pan motor 64 and the main substrate 70 on the bottom unit 40 B of the tilt support member 40, it is possible to dispose the drive mechanism in such a way that it does not enter into the angle of view of the image capturing units 10. In addition, a first cable guide 71 and a second cable guide 72 are disposed in the space that is interposed between the tilt drive unit 50 and the tilt support units 40 A of the tilt support member 40. A first through a fourth cable 73 A, 73 B, 73 C, and 73 D are each a cable that electrically transmits an image capturing signal from the four image capturing units 10, and are connected to the main substrate 70 along either the first cable guide 71 or the second cable guide 72. The main substrate 70 processes the image capturing signal.

In the above arrangement, the first through fourth cables 73 A, 73 B, 73 C, and 73 D do not interfere with the tilt drive member 50, and can also be disposed in a way that utilizes the space inside of the housing unit 110. The enlargement of the entirety of the surveillance camera 100 can thereby be prevented.

By the above configuration, in a surveillance camera, electrical pan and tilt driving is possible while also achieving space saving for the entirety of the surveillance camera, making a reduction in size possible.

### Second Embodiment

Next, a surveillance camera 200 of a second embodiment will be explained.

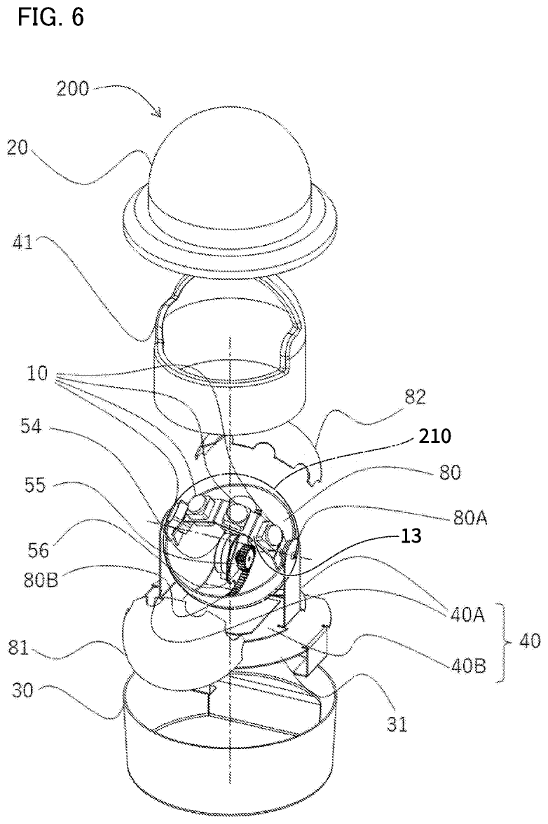

FIG. 6 is an exploded perspective diagram showing the internal structure of the surveillance camera 200 in the second embodiment. Note that, in the present embodiment, the same reference numbers are attached to the members or elements that have the same configurations as those that have been explained in Embodiment 1, and redundant disclosures have been omitted.

In the present embodiment, the housing 210 is provided with a first image capturing unit case 80, a second image capturing unit case 81, and a third image capturing unit case 82. The first image capturing unit case 80, which has a tilt shaft 80 A, as well as the second image capturing unit case 81, and the third image capturing unit case 82 are fixed to the image capturing unit support member 13.

The first image capturing unit case 80 has a gear member 80 B, which is disposed on the inner side of the housing 110, and is included in the tilt drive unit 50 along with the tilt motor 54, the tilt motor bracket 55, and a pinion 56. The gear member 80 B may be, for example, a fan shaped gear. In a case in which, for example, the tilt rotatable range of the surveillance camera is 0° to 90°, the gear member 80 B is disposed on the opposite side of the four image capturing units 10 with the tilt axis serving as the reference. The gear member 80 B is engaged with the pinion 56, and therefore, the four image capturing units 10 can be tilt rotated by driving the tilt motor 54.

The tilt motor bracket 55 is fixed to the bottom unit 40 B of the tilt support member 40, and is also disposed in the space that is interposed between the two tilt support units 40 A. In addition, a portion of the tilt drive unit 50 is disposed in the interior of the housing 110, on which the four image capturing units 10 are disposed. In other words, a portion of the tilt drive unit 50 is disposed so as to push into the housing unit 110. The enlargement of the entirety of the surveillance camera 200 can thereby be prevented, while the tilt drive unit 50 can also be prevented from entering into the angle of view of the image capturing units 10.

### Other Embodiments

Preferred embodiments of the present invention have been explained above, however, the present invention is not limited to these embodiments, and various modifications or alterations can be made within the scope of the essentials thereof.

In the embodiments disclosed above, although a synthesized image is captured by four image capturing units 10, the number of image capturing units may be two or more. In addition, in the embodiments disclosed above, an even greater effect can be achieved in a case in which synthesized images such as panorama images or the like are separately captured by the plurality of image capturing units 10. However, the separate capturing of the synthesized images is not a prerequisite.

In addition, in the embodiments described above, the electrical transmission cables from the image capturing units are wired on either side of the tilt drive unit 50 by the first cable guide 71 and the second cable guide 72. However, they may also be wired on just one side by one cable guide.

This application claims the benefit of Japanese Patent Application No. 2021-004059, filed Jan. 14, 2021, which is hereby incorporated by reference herein in its entirety.

What is claimed is:

1. An image capturing apparatus comprising:
a plurality of image capturing units configured to capture images in directions that differ from one another,
an approximately spherical housing configured to house the plurality of image capturing units and to be rotatable around a tilt axis, and
a drive unit configured to drive the housing to rotate around a tilt axis,
wherein at least a portion of the drive unit is disposed in the interior of the housing.

2. The image capturing apparatus according to claim 1, wherein the drive unit is disposed in a space that is surrounded by the plurality of image capturing units.

3. The image capturing unit according to claim 1, wherein the drive unit comprises a power transmitting unit that is connected to the imaging units, and
the power transmitting unit is disposed in the interior of the housing.

4. The image capturing apparatus according to claim 1, comprising support members configured to support the plurality of image capturing units, and
a base member configured to pan-rotatably support the support members.

5. The image capturing apparatus according to claim 1, wherein the drive unit comprises a timing belt and a pulley.

6. The image capturing apparatus according to claim 1, wherein the drive unit comprises a gear.

7. The image capturing apparatus according to claim 1, comprising an image generating unit configured to generate panorama images by synthesizing a plurality of images that are captured by the plurality of image capturing units.

8. The image capturing apparatus according to claim 1, wherein the image capturing apparatus is able to communicate with an external information processing apparatus, and the drive unit is configured to drive the image capturing units based on commands from the information processing apparatus.
